(19) United States
(12) Patent Application Publication
(10) Pub. No.: US 2007/0277410 A1
(43) Pub. Date: Dec. 6, 2007

(54) Employee workstation attandance device

(76) Inventor: Brian Christopher Warkentine, N. Richland Hills, TX (US)

Correspondence Address: BRIAN C. WARKENTINE, 5113 NANCY LANE, N. RICHLAND HILLS, TX, 76180, US

(21) Appl. No.: 11/442,762

(22) Filed: May 30, 2006

(51) Int. Cl. G09F 11/02

(52) U.S. Cl. 40/493

(57) ABSTRACT

A signal device including a plurality of visually different displays mounted within housing and displays rotated by user to display one desired message at a time, so that the status of the workstation user can be visually determined. And signal device is attached to the top of the cubicle wall.

The present invention is directed to a device for visually communicating the status of a workstation user to others. The invention relates especially to a signal device that can be attached to the upper part of a workstation or cubicle wall, so that persons who are able to se the top of the wall are able to quickly determine if the user is present or absent and if absent the reason why.

Essentially, the signal device of the present invention is comprised of a plurality of different displays that are rotated within a housing to display the appropriate status the user would like to convey to other persons. The individual displays are visually different, combining a preprinted message with a unique corresponding color so persons within the work area at far distances can understand the message. The difference in the displays will be apparent from either of the two sides, so that the desired information can be determined from multiple directions.

As used herein, the term “display” is intended to mean an indicator that is displayed to communicate a desired message by its user. Thus, “display” is defined herein as printed matter thus displayed. The type written messages on each display will communicate different information to an observer. For example on display may be have the words “Lunch” displayed in bold black letters with a yellow background, lunch meaning the user is unavailable and is on a lunch break, and the yellow background conveying a similar message that the user is of attendance however, not available if the printed words “Lunch” are not visible from the observer's point of view.

The plurality of the displays are attached or printed onto a cylinder and that cylinder housed within a outer housing with two separate cutouts or windows to display one message or printed display at one time by its user by rotating the inner cylinder within the outer housing. Alternatively, the inner cylinder can be rotated to expose the desired message the user would desire to convey to the observer.

The device is designed to be attached to the topside of an existing cubicle or workstation wall with a gripping member such as adhesive strips to secure the device.

### BACKGROUND OF THE INVENTION

(1) Field of the Invention

The present invention relates generally to a display device for use in association with a cubicle or workstation, and in particular to a display device for use on top of a cubicle wall to visually indicate the status of the person normally occupying the workstation.

(2) Description of the Prior Art

Modern work environments, instead of being constructed of fixed offices with floor to ceiling walls, are often formed by dividing large open rooms into multiple workstations, or cubicles, which can serve as offices, or specialized work areas assigned to one user. These workstations are formed using movable partitions called cubicle walls. The cubicle walls may be of different heights, widths, and lengths. Generally the walls are low enough that the average person with in the office area can see the top of the cubicle walls. A cubicle wall commonly found in office environments is approximately 4 to 6 feet high, 1 to 3 inches thick, and 2 to 10 feet long. Cubicle walls are normally formed of an outer frame that forms the top, bottom and end sections of the cubicle walls, and side sections extending across the frame.

Work environments of this nature are commonly comprised of a large number of cubicle/workstations extending over a large open office area. One of the needs observed by an individual working in a modern office within cubicles is to determine the status of the user of another workstation, i.e., whether or not the user of another workstation is: Gone Home, Meeting, On Duty, On Break, or At Lunch, etc. For which the preceding examples would be printed onto the Invention and displayed by the user to convey the appropriate message to fellow co-workers. While the height of the average height to see over the wall while standing, and view the topes of cubicle walls forming other workstations, a user seated inside a workstation normally cannot be seen by those in other workstations.

Thus, if the user of the one workstation or visitor wishes to communicate with the user of another workstation the first workstation user must physically go to the second workstation, telephone, or find the meaning of several colored flags. In the first case considerable time can be wasted in obtaining any of the following information.

Therefore, it would be highly convenient if there was a means whereby the user of one workstation or visitor could easily and effectively determine the status of the user of another workstation, without the need to find the meaning of a raised flags color, physically going to or calling another workstation.

### SUMMARY OF THE INVENTION

The present invention is directed to a device for visually communicating the status of a workstation user to others.

The invention relates especially to a signal device comprised of a rotating cylinder with printed messages and a housing to be attached to the upper portion of a workstation or cubicle wall within sight of others in the office to quickly determine if the user is present or absent, and there current status and or situation of that user.

The invention is a signaling device comprised of a cylinder with information printed in segments thereon. The cylinder is housed within an outer housing with a two cut out sections that exposes one message at a time by rotating the inner cylinder. The individual messages are printed with different sayings, so that a different printed message will be communicated by rotating the inner cylinder. The different printed messages are apparent from two sides of the outer housing so that the desired information can be determined from either direction.

The base or bottom of the signaling device is flat so that it can be mounted to the upper portion of a existing cubicle or workstation wall using a double sided adhesive strip to attach the signaling device to the wall.

Devices to communicate information visually on a workstation or cubicle wall are per se known in the prior are. For example, U.S. Pat. No. 6,014,942 describes a plurality of visually different flags in a mounting frame secured to the top of a cubicle wall, so that the status of the workstation user can be determined by the color of the flag raised.

U.S. Pat. No. 5,574,268 describes a two-digit game display counter in which a manually changeable player's score is displayed on two sets of wheels having numeric indicia inverted from each other for easy reading by multiple players. However, while the signal device is comprised of a plurality of visually different rotating displays to communicate a signal or information, the prior art does not suggest the use of the device of this type in association with the movable partitions or cubicle walls of a workstation to inform others of the status of the workstation user.

U.S. Pat. No. 3,323,485 describes an indicator board used to indicate the presence or absence of physicians by flipping an indicator up or down to display a different color.

Accordingly, one aspect of the present invention is to provide a signal device to be mounted on the upper part of a workstation wall, whereby the status of the workstation user can be determined by viewing the top of the workstation wall, the device comprising of a housing attached to the wall, and at least two different printed messages that can be independently displayed.

This and other aspects of the present invention will become apparent to those skilled in the art after a reading of the following description of the preferred embodiment.

### BRIEF DESCRIPTION OF THE DRAWINGS

FIG. 1 is a perspective view of an embodiment of the invention designed for mounting on the top of an existing cubicle wall.

### DETAILED DESCRIPTION OF THE INVENTION

In the following description, terms such as adjacent, extend, convey, desirably, and the like, are used solely for the purpose of clarity in illustrating the invention, and should not be taken as words of limitation.

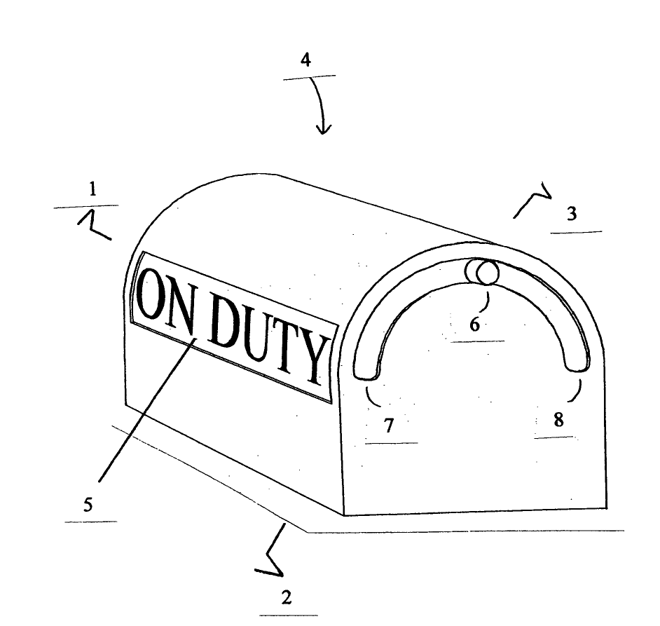

FIGS. 1-1 illustrate a display-signaling device, generally 4, designed for mounting on an existing cubicle/workstation wall. Mounting to be made to the cubicle/workstation wall with the use of double-sided adhesive tape within a visible area of others within the work environment, desirably a top of the cubicle/workstation wall, adjacent to a doorway or passageway. Device 4 to be comprised of an outer housing 1-3 and a inner cylinder/display 5, that is be rotated/adjusted by a knob that extends through the housing 6 through an opening in the outer housing 7-8. By rotating the inner housing by the use of the knob 6, the inner housing can be rotated to display 6, the appropriate status of the workstation user desires to convey to others within their work environment. Operation of the display device is both easily used effective, and visually appealing. Once the device 1-1 is mounted upon a cubicle wall is only necessary for the user of the workstation to position the knob that extents though the outer housing to reflect the appropriate message the user would like to convey to others with in their work environment. Anyone with in the users work environment who wishes to determine the status of the workstation user can then merely read the displayed message or if the distance it too great to read the message the colored background unique to each message would be visible from a greater distance allowing the device to be an effective tool in communicating the status on the workstation user from any distance.

What is claimed is:

1. A cubicle/workstation comprising
a) a cubicle wall having an upper horizontal surface, vertical front and back wall segments, and a given thickness, said upper horizontal surface.
b) A display signal device mounted atop of said cubicle wall to visually indicate the status of a user of said cubicle/workstation by viewing the top of the cubicle wall.
i) a plurality of printed displays with unique colored back grounds printed on the inner cylinder and being pivotal upon an axle, mounted within an outer housing in which one unique message is display upon two sides at the time.
